(19) United States
(12) Patent Application Publication
(10) Pub. No.: US 2018/0249674 A1
(43) Pub. Date: Sep. 6, 2018

(54) Hanging Pet House

(71) Applicant: James Donald Koskey, JR., Manitou Springs, CO (US)

(72) Inventor: James Donald Koskey, JR., Manitou Springs, CO (US)

(21) Appl. No.: 15/448,907

(22) Filed: Mar. 3, 2017

(51) Int. Cl. A01K 1/03; A01K 1/00; D03D 27/00; D03D 1/00

(52) U.S. Cl. CPC A01K 1/033; D03D 1/0017; D03D 27/00; A01K 1/0064

(57) ABSTRACT

A hanging pet house has a first frame and a second frame. A fabric housing has a number of detachable sleeves that attach to the first frame and the second frame. A pair of connectors attach to a wall or window. A pair of strings attach to the pair of connectors and the second frame. Because the hanging pet house connects to a window it is out of the way and allows the cat to look outside and bask in the sun. The hanging pet house folds down into a small package that is easy to ship and does not take up a lot of shelf space

### BACKGROUND OF THE INVENTION

Cats are becoming more and more popular as pets. Many of these cats are indoor cats or cats whose owners live in apartments with limited space. In both cases cats enjoying playing in and on cat houses, however present cat houses clutter the living area of the house or apartment. Present cat houses are commonly made of bulky materials that are heavy and therefore expensive to ship. Shipping costs can be a significant portion of the cost at retail for these houses. There have been attempts to build a cat perch or house that hung from a door and this saved space, but it was not secure. The house or perch swung when a cat attempt to jump on the house. The cats did not like this and refused to use the device.

Thus there exists a need for a space saving, secure, lightweight, compact for shipping cat house.

### BRIEF SUMMARY OF INVENTION

A hanging pet house that overcomes these and other problems has a first frame and a second frame. A fabric housing has a number of detachable sleeves that attach to the first frame and the second frame. A pair of connectors attach to a wall or window. A pair of strings attach to the pair of connectors and the second frame. Because the hanging pet house connects to a window it is out of the way and allows the cat to look outside and bask in the sun. The hanging pet house folds down into a small package that is easy to ship and does not take up a lot of shelf space.

### BRIEF DESCRIPTION OF THE SEVERAL VIEWS OF THE DRAWINGS

FIG. 1 is a top right perspective view of a hanging pet house in accordance with one embodiment of the invention;

FIG. 2 is a top left perspective view of a hanging pet house in accordance with one embodiment of the invention;

FIG. 3 is a front tight perspective view showing the reclosable sleeves of a hanging pet house in accordance with one embodiment of the invention;

FIG. 4 is an exploded view of a skeletal structure of a hanging pet house in accordance with one embodiment of the invention; and

FIG. 5 is a frame in accordance with one embodiment of the invention.

### DETAILED DESCRIPTION OF THE INVENTION

The invention is directed to a hanging pet house that has a first frame and a second frame. A fabric housing has a number of detachable sleeves that attach to the first frame and the second frame. A pair of connectors are attached to a wall or window. A pair of strings is attached to the pair of connectors and the second frame. Because the hanging pet house connects to a window it is out of the way and allows the cat to look outside and bask in the sun. The hanging pet house folds down into a small package that is easy to ship and does not take up a lot of shelf space.

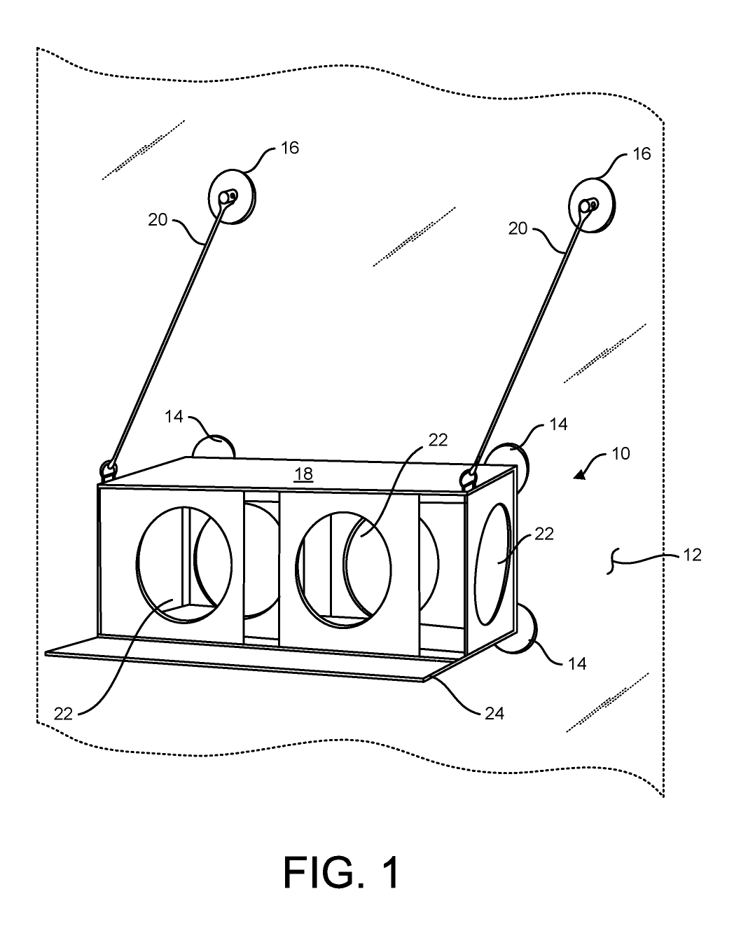

FIG. 1 is a top right perspective view of a hanging pet house 10 in accordance with one embodiment of the invention. The hanging pet house 10 is attached to a window 12 by a plurality of suction cups 14, 16. The top suction cups 16 are attached to the house structure 18 by strings or wires 20. The house structure 18 has a number of windows 22 and a balcony 24. While this figure shows suction cups other connectors may also be used such as double side foam tape.

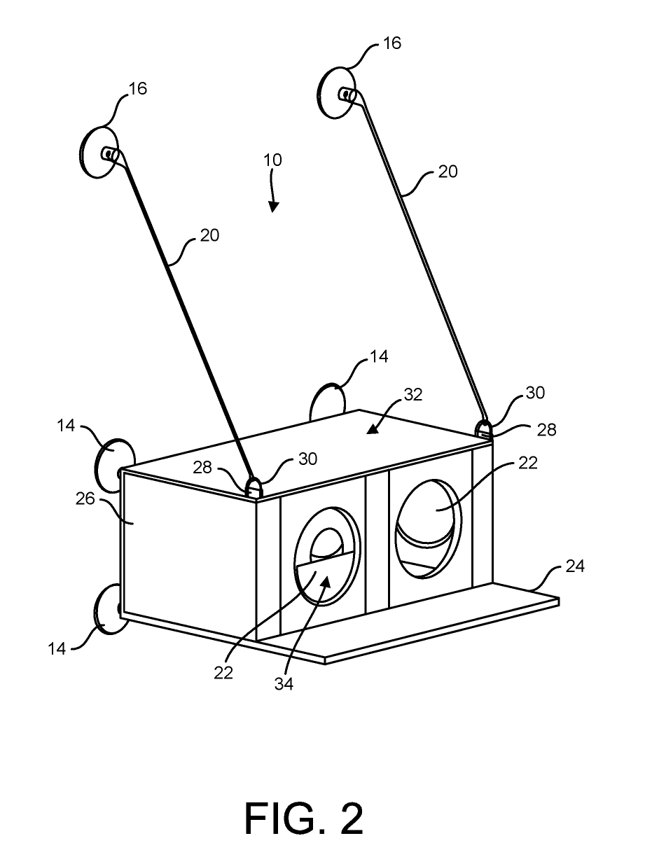

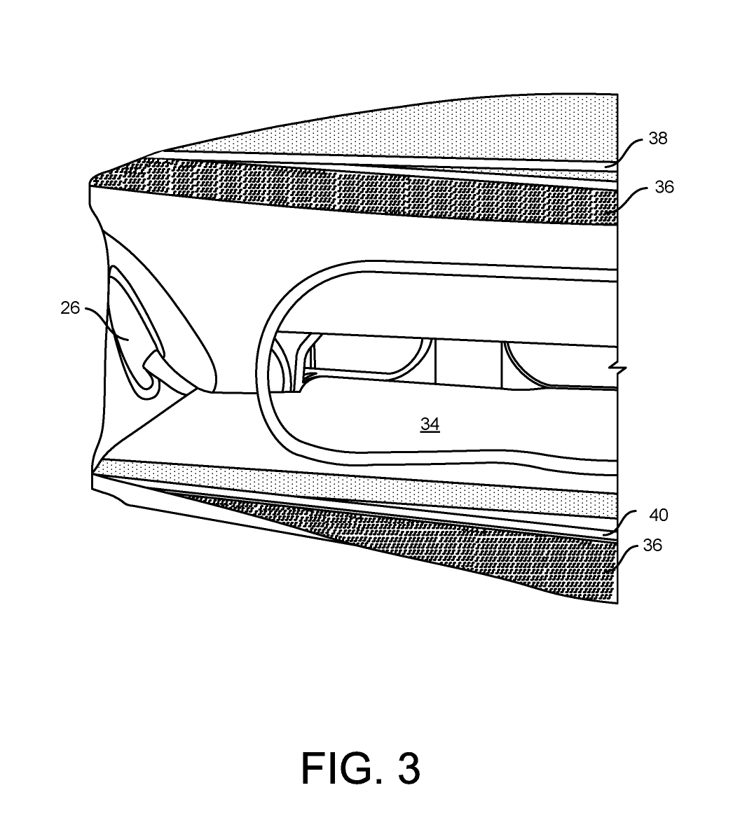

FIG. 2 is a top left perspective view of a hanging pet house 10 in accordance with one embodiment of the invention. The hanging pet house 10 has a fabric housing 26 with a pair of metal frames that can be seen in FIGS. 3 & 4. The fabric housing 26 has a pair of cloth tabs 28 that hold metal rings 30. The metal rings attach to the metal strings 20. The roof 32 is made of a nap weave fabric, which cats enjoy sleeping on. The same is true of the floor 34.

FIG. 3 is a front tight perspective view showing the reclosable sleeves 36 of a hanging pet house in accordance with one embodiment of the invention. The detachable sleeve are closed around the frames 38, 40 to give the fabric housing 26 some structure. The sleeves 36 are formed around the periphery of the roof 32 and floor 34.

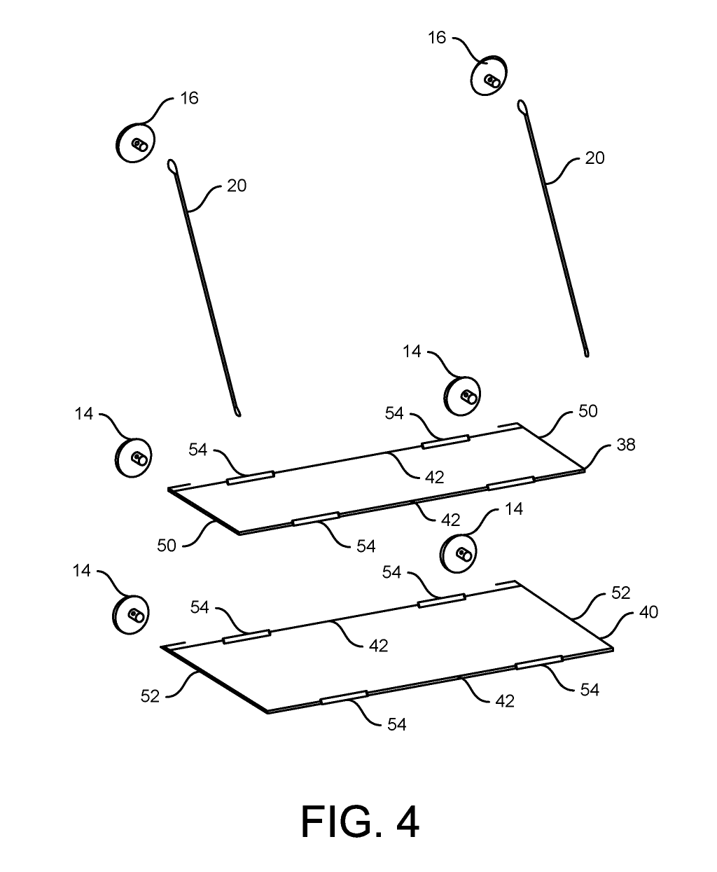

FIG. 4 is an exploded view of a skeletal structure of a hanging pet house in accordance with one embodiment of the invention. The structure has six suction cups 14, 16, a pair of strings 20 and a pair of frames 38, 40. The lower frame 40 is slightly larger than the upper frame 38. In this embodiment, the frames 38, 40 are shown as being made up of a number of frame sections 42, 50, 52 and connectors 54. In another embodiment the frames are solid.

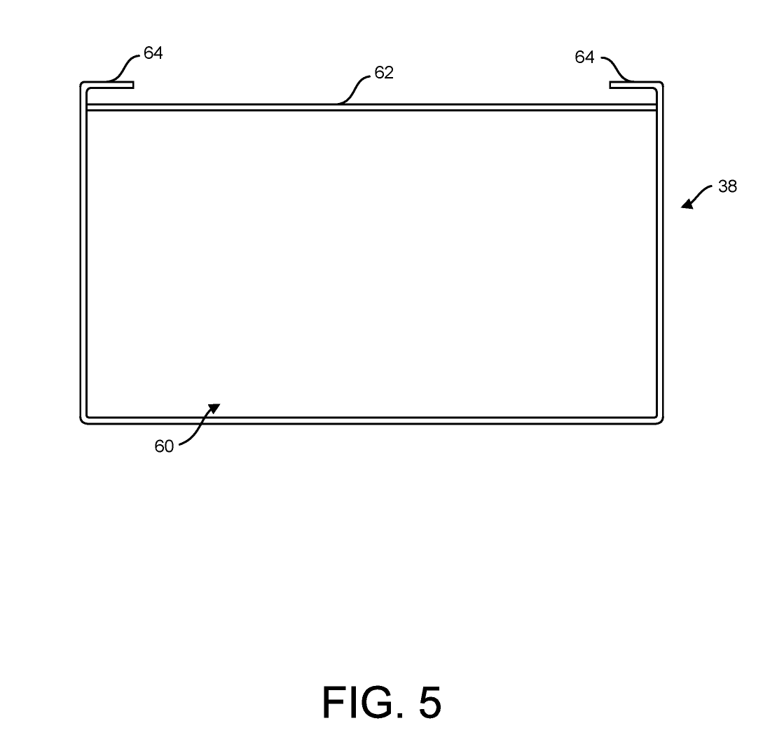

FIG. 5 is a frame 38 in accordance with one embodiment of the invention. The frame 38 has a rectangular section 60 and along one side 62 are pair of L-shaped extensions 64 the suction cups 14 are attached to these extensions. Note that the extension 64 are in the same plane as the rectangle.

Thus there has been described a hanging pet house that connects to a window and is out of the way and allows the cat to look outside and bask in the sun. The hanging pet house folds down into a small package that is easy to ship, easy to assemble, and does not take up a lot of shelf space.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1. A hanging pet house, comprising:
a first frame;
a second frame;
a fabric housing having a plurality of detachable sleeves that attach to the first frame and the second frame;
a pair of connectors; and
a pair of strings attached to the pair of connectors and the second frame.

2. The hanging pet house of claim 1, wherein the first frame has a first rectangular portion and a first pair of L-shaped extensions attached to a first side of the first rectangular portion.

3. The hanging pet house of claim 2, wherein the second frame has a second rectangular portion and a second pair of L-shaped extensions attached to a first side of the second rectangular portion, wherein the first rectangular portion is larger than the second rectangular portion.

4. The hanging pet house wherein the pair of connectors are suction cups.

5. The hanging pet house of claim 4, further including four suctions cups that attach to the first pair of L-shaped extensions and the second pair of L-shaped extensions.

6. The hanging pet house of claim 5, wherein the hanging pet house has an enclosed portion and a balcony.

7. The hanging pet house of claim 6, wherein the plurality of detachable sleeves are formed with a hook and loop strips.

8. The hanging pet house of claim 7, wherein the first pair of L-shaped extensions are in the same plane as the first rectangular portion of the first frame.

9. The hanging pet house of claim 8, wherein a floor section and a roof section of the fabric housing has a nap weave.

10. The hanging pet house of claim 9, further including a pair of connector rings attached to the fabric housing.

11. A hanging pet house, comprising:
a fabric structure having a plurality of reclosable sleeves;
a first frame have a portion enclosed by one of the plurality of reclosable sleeves;
a second frame have a portion enclosed by a second of the plurality of reclosable sleeves;
a string attached to the fabric structure; and
an attachment device.

12. The hanging pet house of claim 11, wherein the attachment device is a suction cup.

13. The hanging pet house of claim 12, where the first frame has a rectangular portion and an extension.

14. The hanging pet house of claim 13, further including a second suction cup attached to the extension.

15. The hanging pet house of claim 14, wherein the string is a metal cable.

16. The hanging pet house of claim 15, wherein the fabric structure has an enclosed space and a balcony.

17. The hanging pet house of claim 16, wherein a floor section of the fabric structure has a nap weave.

18. The hanging pet house of claim 17, wherein the fabric structure has a plurality of windows.

19. The hanging pet house of claim 17, wherein the fabric structure has a screen section.
